(19) United States
(12) Patent Application Publication
(10) Pub. No.: US 2015/0073731 A1
(43) Pub. Date: Mar. 12, 2015

(54) FLOW METER DEVICE

(71) Applicant: Panasonic Intellectual Property Management Co., Ltd., Osaka-shi, Osaka (JP)

(72) Inventors: Mitsuo Yokohata, Osaka (JP); Motoyuki Nawa, Nara (JP)

(21) Appl. No.: 14/394,566

(22) PCT Filed: Apr. 17, 2013
(86) PCT No.: PCT/JP2013/002589

§ 371 Date: Oct. 15, 2014

(30) Foreign Application Priority Data
Apr. 17, 2012 (JP) 2012-093625

(51) Int. Cl. G01F 1/00

(52) U.S. Cl. CPC G01F 1/00
USPC 702/45

(57) ABSTRACT

A flow meter device comprises a flow measuring section (2) for measuring a flow of a fluid in a fluid passage through which the fluid is supplied to a fluid instrument in use; and a measurement data processing section (3) which calculates a slope of a change in a flow difference per unit time which change occurs with time, at a time point when a sign of the flow difference per unit time is inverted, based on the flow of the fluid measured by the flow measuring section, and determines whether or not the fluid instrument in use is a particular fluid instrument based on whether or not the slope falls within a predetermined range.

### TECHNICAL FIELD

The present invention relates to a flow meter device which determines a gas instrument in use based on a gas flow.

### BACKGROUND ART

Conventionally, in general, there is known a technique for identifying a gas instrument based on a flow value unique to the gas instrument (see e.g. Patent Literature 1).

A gas meter relating to this technique includes a flow measuring means which is connected to a home gas supply pipe and measures a gas flow value, and an instrument determiner means which compares the gas flow value measured by the flow measuring means to the flow patterns of the gas instruments for use which are stored in a registration storage means to determine a gas instrument in use (gas instrument which is now using a gas).

### CITATION LIST

### Patent Literature

Patent Literature 1: Japanese Laid-Open Patent Application Publication No. 2006-200802

### SUMMARY OF THE INVENTION

### Technical Problem

However, in a case where different gas instruments which are equal in gas flow value, exist, among the above stated conventional gas instruments, it is difficult to determine the gas instrument in use based on the flow pattern.

The present invention is directed to solving the above described problem associated with the prior art, and an object of the present invention is to provide a flow meter device which is capable of determining whether or not a fluid instrument in use is a particular fluid instrument, even when there exist fluid instruments which use the fluid and are equal in flow value.

### Solution to Problem

To solve the above described problem associated with the prior art, according to an aspect of the present invention, a flow meter device comprises: a flow measuring section for measuring a flow of a fluid in a fluid passage through which the fluid is supplied to a fluid instrument in use; and a measurement data processing section which calculates a slope of a change in a flow difference per unit time which change occurs with time, at a time point when a sign of the flow difference per unit time is inverted, based on the flow of the fluid measured by the flow measuring section, and determines whether or not the fluid instrument in use is a particular fluid instrument based on whether or not the slope falls within a predetermined range.

### Advantageous Effects of Invention

A flow meter device of the present invention is able to determine whether or not a fluid instrument in use is a particular fluid instrument, even when there exist fluid instruments which are equal in flow value.

### BRIEF DESCRIPTION OF THE DRAWINGS

FIG. 1 is a view showing a heating power adjustment knob of a stove burner connected to a flow meter device according to an embodiment of the present invention.

FIG. 2 is a block diagram showing the exemplary configuration of the flow meter device of FIG. 1.

FIG. 3 is a flowchart showing the exemplary operation of the flow meter device of FIG. 1.

FIG. 4 is a time chart of the flow meter device of FIG. 1.

FIG. 5 is a flowchart showing the exemplary operation of a flow meter device according to a modified example of the embodiment of the present invention.

### DETAILED DESCRIPTION OF THE PREFERRED EMBODIMENTS

According to a first aspect of the present invention, a flow meter device comprises: a flow measuring section for measuring a flow of a fluid in a fluid passage through which the fluid is supplied to a fluid instrument in use; and a measurement data processing section which calculates a slope of a change in a flow difference per unit time which change occurs with time, at a time point when a sign of the flow difference per unit time is inverted, based on the flow of the fluid measured by the flow measuring section, and determines whether or not the fluid instrument in use is a particular fluid instrument based on whether or not the slope falls within a predetermined range.

In accordance with this configuration, it becomes possible to accurately determine whether or not the fluid instrument which is now using the fluid is the particular fluid instrument.

According to a second aspect of the present invention, the flow meter device of the first aspect may further comprise a history storage section for storing a history of the flow measured by the flow measuring section, and the measurement data processing section may identify at least one of a time when a use of the particular fluid instrument has started and a time when the use of the particular fluid instrument has ended, based on the history of the flow stored in the history storage section, when the measurement data processing section determines that the fluid instrument in use is the particular fluid instrument.

This makes it possible to integrate the amount of the fluid used in the particular fluid instrument.

According to a third aspect of the present invention, in the flow meter device of the second aspect, the measurement data processing section may identify the time when the use of the particular fluid instrument has started, based on an event that the history of the flow corresponding to the determination has started to rise from a predetermined flow.

This makes it possible to accurately identify the time when the use of the particular fluid instrument has started.

According to a fourth aspect of the present invention, in the flow meter device of the second aspect, the measurement data processing section may identify the time when the use of the particular fluid instrument has ended, based on an event that the history of the flow corresponding to the determination has fallen to a predetermined flow and finishes changing. As defined herein, the phrase “flow falls” means that the flow changes to the predetermined flow with a certain slope.

This makes it possible to accurately identify the time when the use of the particular fluid instrument has ended.

Hereinafter, the embodiment of the present invention will be described with reference to the drawings. Note that the present invention is not limited by the present embodiment. Hereinafter, throughout the drawings, the same or corresponding components are designated by the same reference symbols and will not be described repeatedly.

(Finding which is a Basis of the Present Invention)

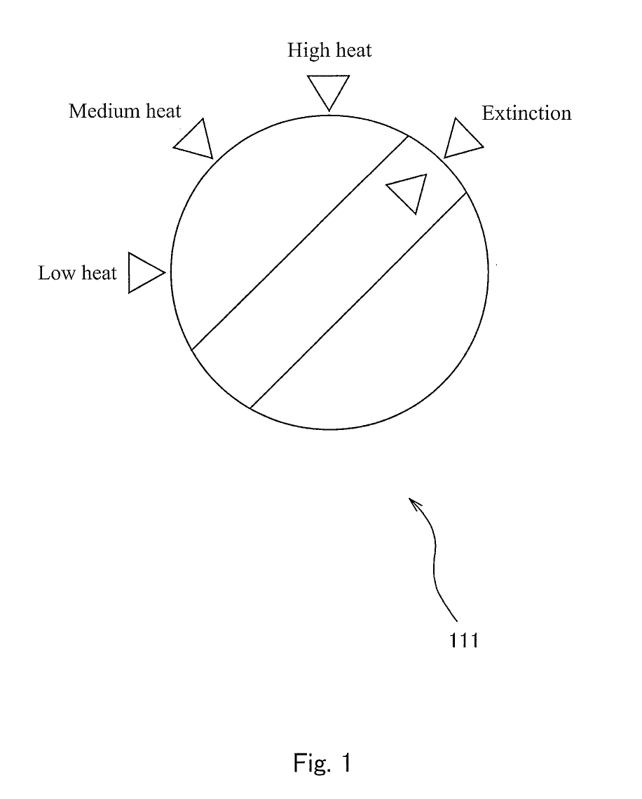

FIG. 1 is a view showing a heating power adjustment knob 111 of a stove burner having a particular characteristic.

The present invention is on the basis of the finding about the particular characteristic of the stove burner as described below.

As shown in FIG. 1, this stove burner includes the heating power adjustment knob 111 coupled to a manipulation shaft, and is configured to adjust the flow of a gas supplied to a burner by rotation of the heating power adjustment knob 111.

This stove burner is configured such that a low heat position, a medium heat position, a high heat position, and an extinction position of the heating power adjustment knob 111 are arranged in this order in a clockwise direction.

When the heating power adjustment knob 111 is rotated in a counterclockwise direction from the extinction position in this stove burner, the gas starts to be supplied to a burner of the stove burner with a maximum flow. When the heating power adjustment knob 111 is rotated in the counterclockwise direction, the flow of the gas supplied to the burner is gradually decreased. When the heating power adjustment knob 11 is rotated from the low heat position to the extinction position, the amount of the gas supplied to the burner is gradually increased, and the gas is supplied to the burner with a maximum flow just before the heating power adjustment knob 111 reaches the extinction position. When the heating power adjustment knob 111 is further rotated from this position in the clockwise direction and reaches the extinction position, the gas supplied to the burner is cut-off.

The present invention is on the basis of the finding about the stove burner having the above stated characteristic.

### Embodiment

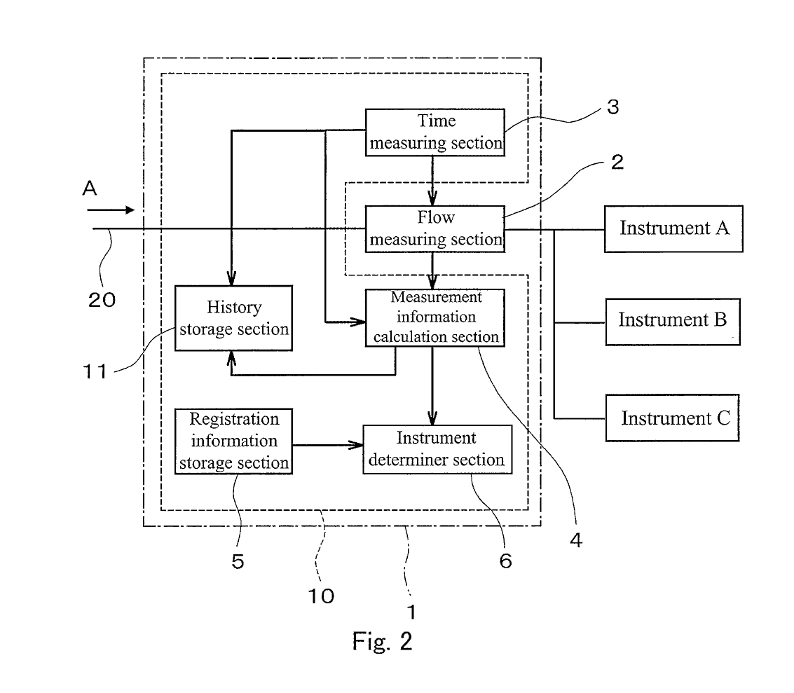

The embodiment of the present invention will be described with reference to FIGS. 2 to 6.

### (Configuration)

FIG. 2 is a block diagram showing the exemplary configuration of a flow meter device 1 according to the embodiment of the present invention.

As shown in FIG. 2, the flow meter device 1 is attached to a fluid passage 20 through which a target fluid is supplied to a fluid instrument (instrument) A, a fluid instrument B, and a fluid instrument C which are connected to the fluid passage 20 at a downstream side. The fluid instruments A to C are instruments which use the supplied target fluid and are connected in parallel with the flow meter device 1. In the present embodiment, the target fluid is a city gas but is not limited to this. The present invention is applicable to various kinds of liquids and gasses without changing the spirit of the present invention. Although a stove burner, a hot water storage unit, and a heating appliance are exemplarily described as the fluid instrument which uses the city gas, the fluid instrument is not limited to these.

The flow meter device 1 includes a flow measuring section 2, and a measurement data processing section 10.

The flow measuring section 2 measures a flow (flow rate) Q of the target fluid flowing in the fluid passage 20. In the present embodiment, the flow measuring section 2 is, for example, an ultrasonic measuring section, and is configured to measure the flow Q of the target fluid by utilizing a transit time (propagation time) of an ultrasonic wave. Note that the measuring method of the flow measuring section 2 is not limited to this. The flow measuring section 2 measures the flow Q of the target fluid in the fluid passage 20 at a predetermined timing based on a signal from a time measuring section 3 as will be described later.

The measurement data processing section 10 includes a control unit including a processor, such as a CPU, and a storage section including memories such as ROM and RAM. The measurement data processing section 10 may be configured as a single control unit which performs centralized control or a plurality control units which cooperate with each other to perform distributed control.

The measurement data processing section 10 includes a time measuring section 3, a measurement information calculation section 4, a registration information storage section 5, an instrument determiner section 6, and a history storage section 11. The time measuring section 3, the measurement information calculation section 4, and the instrument determiner section 6 are functional blocks implemented by the control section's operation for executing predetermined control programs stored in the storage section.

The time measuring section 3 is a processing section which outputs a timing signal at predetermined time intervals (sampling intervals). In the present embodiment, the time measuring section 3 outputs the timing signal at time intervals of 0.5 s.

The measurement information calculation section 4 performs calculations based on the flow Q of the target fluid which is measured by the flow measuring section 2 at the predetermined time intervals and the time information from the time measuring section 3. The processing performed by the measurement information calculation section 4 includes processing for calculating a flow difference m per unit time, processing for determining whether or not there is a time point when a sign of the flow difference m per unit time is inverted, processing for calculating a slope θ of the flow difference m per unit time, and processing for determining whether or not the slope θ falls within a predetermined range.

The flow difference m per unit time is a value with a sign and is decided based the following formula:

m=ΔQ/Δt

ΔQ: change amount with a sign of the flow Q between the predetermined time intervals Δt

Δt: time interval of the timing signal output from the time measuring section 3

The slope θ indicates a slope of a change in the flow difference m per unit time, which change occurs with time, and is decided based on the following formula:

θ=Δm/Δt

The registration information storage section 5 contains the numeric value range of the slope θ corresponding to at least one fluid instrument. This numeric value range is a value which is found in advance by an experiment and set.

The instrument determiner section 6 identifies that a fluid instrument in use (fluid instrument which is now using the fluid) is a particular fluid instrument, when the instrument determiner section 6 determines that the slope θ calculated by the measurement information calculation section 4 falls within the numeric value range of the slope θ which is stored in the registration information storage section 5.

The history storage section 11 stores the history of the flow Q at a time t which is measured by the flow measuring section 2, and the history of the flow difference m per unit time at the time t.

In FIG. 2, arrows indicates the transmission direction of signals.

### (Exemplary Operation)

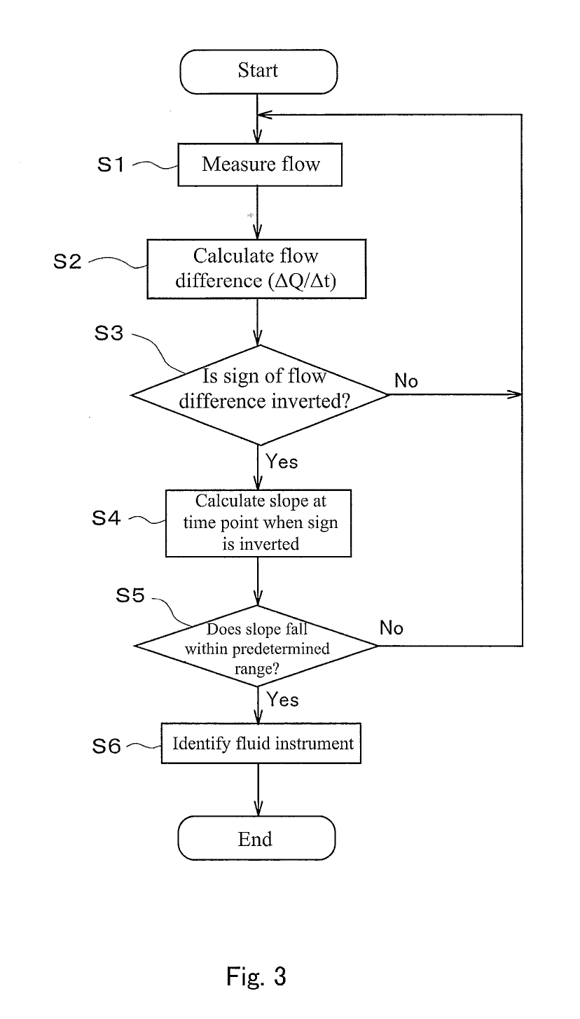

FIG. 3 is a flowchart showing the exemplary operation of the flow meter device 1.

When the target fluid flows into the flow measuring section 2 of the flow meter device 1 from the direction of an arrow A, firstly, in step S1, the flow measuring section 2 measures the flow Q of the target fluid flowing through the fluid passage 20 based on the timing signal from the time measuring section 3. Specifically, the flow measuring section 2 measures the flow Q of the target fluid in the fluid passage 20 at each time Δt defined by the time measuring section 3.

Then, in step S2, the measurement information calculation section 4 of the measurement data processing section 10 calculates the flow difference m per unit time between the flow Q obtained previously and the flow Q obtained in step S1. Then, the measurement data processing section 10 stores in the history storage section 11 the history of the flow Q at the time point t and the history of the flow difference m per unit time at the time point t.

Then, in step S3, the measurement information calculation section 4 of the measurement data processing section 10 determines whether or not the sign of the flow difference m per unit time which is calculated in step S2 is inverted.

When the measurement information calculation section 4 of the measurement data processing section 10 determines that the sign of the flow difference m per unit time is not inverted (No in step S3), the measurement data processing section 10 executes step S1 again.

On the other hand, when the measurement information calculation section 4 of the measurement data processing section 10 determines that the sign of the flow difference m per unit time is inverted (Yes in step S3), the measurement information calculation section 4 of the measurement data processing section 10 calculates the slope θ in step S4.

Then, in step S5, the measurement information calculation section 4 of the measurement data processing section 10 determines whether or not the slope θ falls within a predetermined numeric value range. The predetermined numeric value range of the slope θ is stored in the registration information storage section 5.

When the measurement information calculation section 4 of the measurement data processing section 10 determines that the slope θ does not fall within the predetermined numeric value range (No in step S5), the measurement data processing section 10 executes step S1 again.

On the other hand, when the measurement information calculation section 4 of the measurement data processing section 10 determines that the slope θ falls within the predetermined numeric value range (Yes in step S5), the instrument determiner section 6 of the measurement data processing section 10 determines that the fluid instrument in use is a particular fluid instrument corresponding to the predetermined numeric value range of the slope θ which is stored in the registration information storage section 5. This makes it possible to identify that the fluid instrument having a unique characteristic is in operation.

Then, the target fluid flows into each fluid instrument.

### Example

Hereinafter, a specific example of the present invention will be described in detail with reference to the drawings.

The present example is an example in a case where the stove burner having the above described particular characteristic is used. The fluid instrument A is an instrument of this type. The fluid instrument B and the fluid instrument C are fluid instruments each having only one unique flow.

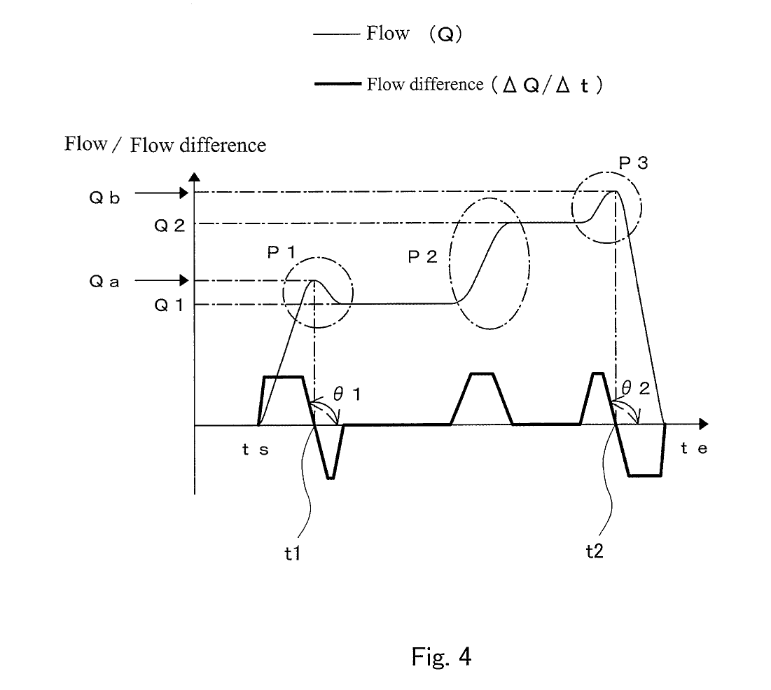

FIG. 4 is a time chart showing the flow Q and the flow difference m in a case where the stove burner (fluid instrument A) having the above described particular characteristic is used. In the time chart, a thin line indicates the change in the flow Q which occurs with time, and a bold line indicates the flow difference m per unit time.

Firstly, the operation performed when a user performs a firing manipulation (manipulation for starting the use of the fluid instrument) will be described.

As shown in FIG. 4, when the user rotates the heating power adjustment knob 111 in the counterclockwise direction from the extinction position toward the medium heat position which is a firing position to fire the stove burner, the gas starts to be supplied to the burner of the stove burner with a maximum flow. Therefore, the flow Q of the gas in the fluid passage 20 which is measured by the flow measuring section 2 is increased up to Qa as indicated by the thin line within a range of P1 of FIG. 4. Thereafter, when the heating power adjustment knob 111 reaches the medium heat position, the flow Q of the gas which is measured by the flow measuring section 2 is decreased from Qa to a set flow Q1 corresponding to the medium heat position. As described above, the flow of the gas is increased up to Qa and thereafter becomes Q1 which is less than Qa.

Therefore, the change in the flow difference m per unit time which is calculated by the measurement information calculation section 4 in step S2, which change occurs with time, is, as indicated by the bold line of FIG. 4, such that the flow difference m per unit time becomes 0 at a time point t1 when the gas is supplied to the burner of the stove burner with a maximum flow, and the sign of the flow difference m per unit time is inverted between a time period that is before the time point t1 and a time period that is after the time point t1. Therefore, the measurement data processing section 10 performs the determination as “Yes” in step S3, calculates a slope θ1 at t1 (step S4) and determines whether or not the slope θ1 falls within the predetermined numeric value range (step S5). When the measurement data processing section 10 determines that the slope θ1 falls within the predetermined numeric value range (Yes in step S5), it determines that the fluid instrument in use is the particular fluid instrument A corresponding to the predetermined numeric value range of the slope θ which is stored in the registration information storage section 5.

As described above, the fluid instrument B and the fluid instrument C are fluid instruments each having only one unique flow. In a case where the fluid instrument B or the fluid instrument C is used, the flow difference m per unit time at the time of firing is changed from 0 to a positive value, and is changed from the positive value to 0 when the gas flow reaches the unique flow of the fluid instrument. Thus, differently from the fluid instrument A, the flow difference m per unit time is not changed continuously from a positive value to a negative value, in the case of the fluid instrument B and the fluid instrument C. Therefore, the measurement data processing section 10 can determine that the fluid instrument in use is the fluid instrument A, rather than the fluid instrument B and the fluid instrument C.

By the way, in a heating power adjusting manipulation, if the heating power adjustment knob 111 is slowly rotated in a specified direction and is slowly rotated in an opposite direction immediately thereafter, the flow difference m per unit time is changed continuously from a positive value to a negative value when the sign of the flow difference m per unit time is inverted. However, in this heating power adjusting manipulation, since a change in the flow of the gas which is measured by the flow measuring section 2 is less than that in a firing manipulation performed typically for a relatively short moment, the slope θ takes a value which is smaller than that in the firing manipulation. Therefore, the measurement information calculation section 4 of the measurement data processing section 10 determines that the slope θ does not fall within the predetermined numeric value range (step S5), and the instrument determiner section 6 does not identify the fluid instrument in use. By defining the value of the slope θ within the predetermined range, it becomes possible to accurately identify the fluid instrument in use.

Next, the operation performed in a case where the user performs the heating power adjusting manipulation will be described.

When the user rotates the heating power adjustment knob 111 in the clockwise direction from the medium heat position toward the high heat position to increase the heating power of the stove burner, from the medium heat to a heating power to be used, the flow Q of the gas supplied to the burner of the stove burner is increased. Specifically, the flow Q of the gas in the fluid passage 20 which is measured by the flow measuring section 2 is increased from Q1 to a set flow Q2 corresponding to a use heating power position of the heating power adjustment knob 111, as indicated by a range P2 of FIG. 4.

Therefore, the flow difference m per unit time which is calculated by the measurement information calculation section 4 in step S2 is changed from 0 to a specified positive value when the heating power adjustment knob 111 is being rotated from the medium heat position toward the high heat position as indicated by the bold line of FIG. 4. When the heating power adjustment knob 111 is stopped at the use heating power position, the flow difference m per unit time is changed from the positive value to 0.

During the heating power adjusting manipulation performed by the user, the sign of the flow difference m per unit time is not inverted. Therefore, the measurement data processing section 10 performs determination as “No” in step S3, and performs step S1 again.

In brief, the measurement data processing section 10 does not perform determination as to the fluid instrument in use, in the heating power adjusting manipulation.

Next, the operation performed in a case where the user performs an extinction manipulation (manipulation for ending the use of fluid instrument) will be described.

When the user rotates the heating power adjustment knob 111 in the clockwise direction from the use heating power position to the extinction position to extinguish the fire of the stove burner, the gas is supplied to the burner of the stove burner with a maximum flow for a moment. Therefore, the flow Q of the gas in the fluid passage 20 which is measured by the flow measuring section 2 is increased up to Qb as indicated by the thin line within a range P3 of FIG. 4. Thereafter, at a time point te, when the heating power adjustment knob 111 reaches the extinction position, the gas supplied to the burner of the stove burner is cut-off, and therefore, the flow Q of the gas which is measured by the flow measuring section 2 becomes 0. Thus, the flow of the gas which is measured by the flow measuring section 2 is increased up to Qb and then is decreased to 0 immediately thereafter.

Therefore, the change in the flow difference m per unit time calculated by the measurement information calculation section 4 in step S2, which change occurs with time is, as indicated by the bold line of FIG. 4 such that the flow difference m per unit time becomes 0 at a time point t2 when the gas is supplied to the burner with a maximum flow, and the sign of the flow difference m per unit time is inverted between a time period before the time point t2 and a time period after the time t2. Therefore, the measurement data processing section 10 performs determination as “Yes” in step S3, calculates a slope θ2 at t2 (step S4), and determines whether or not the slope θ2 falls within the predetermined numeric value range (step S5). Then, the measurement data processing section 10 determines that the slope θ2 falls within the predetermined numeric value range (step S5) and identifies that the fluid instrument in use is the particular fluid instrument A corresponding to the predetermined numeric value range of the slope θ which is stored in the registration information storage section 5.

As described above, in the flow meter device of the present invention, the measurement data processing section 10 calculates the slope θ of the change in the flow difference per unit time, which change occurs with time, at the time point when the sign of the flow difference m per unit time is inverted, and determines whether the fluid instrument in use is a particular fluid instrument based on whether or not the slope θ falls within the predetermined range. This makes it possible to accurately determine that the particular fluid instrument is now in use (in operation), among the fluid instruments connected to the flow meter device 1. Therefore, it becomes possible to detect the use state of a manual manipulation fluid instrument which cannot be easily determined as compared to a micro control device.

### Modified Example

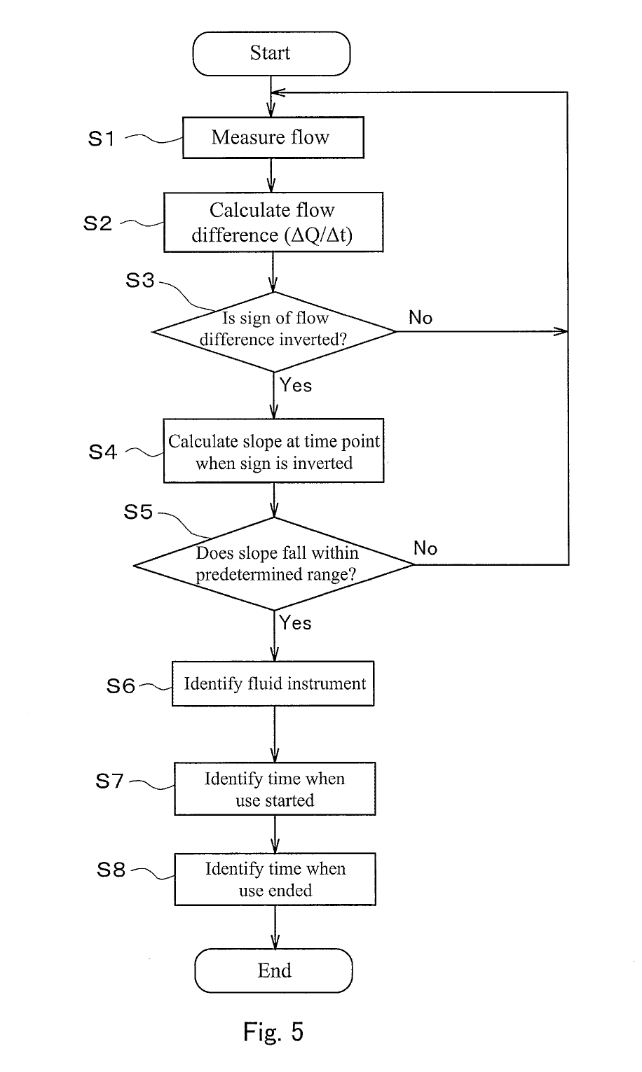

In the above described embodiment, as shown in FIG. 5, the measurement data processing section 10 may identify the time when the use of the particular fluid instrument has started, based on the history of the flow Q stored in the history storage section 11, in a step subsequent to step S6. Specifically, when the measurement data processing section 10 determines that the particular fluid instrument A is now in use due to, for example, the user's manipulation for starting the use of the fluid instrument, it may identify a time point is when the use of the particular fluid instrument has started, based on an event that the history of the flow Q corresponding to this determination has started to rise from a predetermined flow (e.g. 0). This makes it possible to integrate the usage amount of the target fluid from when the use of the target fluid in the particular fluid instrument has started.

In the above described embodiments, as shown in FIG. 5, the measurement data processing section 10 may identify the time when the use of the particular fluid instrument has ended, based on the history of the flow Q stored in the history storage section 11, in a step subsequent to step S6. Specifically, when the measurement data processing section 10 determines that the particular fluid instrument A is now in use due to, for example, the user's manipulation for extinguishing the fire, it may identify a time point to when the use of the particular fluid instrument has ended, based on an event that the history of the flow Q corresponding to this determination finishes changing and converges at the predetermined flow (e.g. 0). This makes it possible to integrate the usage amount of the target fluid until when the use of the target fluid in the particular fluid instrument has ended.

In the present embodiment, the flow measuring section 2 measures the flow of target fluid in the fluid passage 20 at measurement timings of 0.5 second intervals, based on the timing signal received from the time measuring section 3. However, if an instantaneous change in the flow within, for example, the range A or C of FIG. 4, cannot be captured clearly, the unit time of the measurement timing may be shorter than that in the above case.

Although in the present embodiment, the operation performed to identify the fluid instrument in use in the case where one fluid instrument is used simultaneously has been described, the present invention is applicable to determination as to the fluid instrument in use in a case where a plurality of fluid instruments are concurrently used simultaneously. In this case, the flows of the target fluid corresponding to the respective fluid instruments may be calculated based on well-known algorithms and the fluid instrument in use may be identified based on a result of the calculation.

Numeral modifications and alternative embodiments of the present invention will be apparent to those skilled in the art in view of the foregoing description. Accordingly, the description is to be construed as illustrative only, and is provided for the purpose of teaching those skilled in the art the best mode of carrying out the invention. The details of the structure and/or function may be varied substantially without departing from the spirit of the invention.

### INDUSTRIAL APPLICABILITY

As described above, a flow meter device of the present invention is able to reliably determine whether or not a fluid instrument in use is a particular fluid instrument, by determining whether or not a slope of a change in a sign of a flow difference per unit time falls within a predetermined range, and therefore is widely applicable to a technique for determining instruments having such a characteristic.

### REFERENCE SIGNS LIST

1 flow meter device
2 flow measuring section
3 time measuring section
10 measurement data processing section
11 history storage section
20 fluid passage

What is claimed is:

1. A flow meter device comprising:
a flow measuring section for measuring a flow of a fluid in a fluid passage through which the fluid is supplied to a fluid instrument in use; and
a measurement data processing section which calculates a slope of a change in a flow difference per unit time which change occurs with time, at a time point when a sign of the flow difference per unit time is inverted, based on the flow of the fluid measured by the flow measuring section, and determines whether or not the fluid instrument in use is a particular fluid instrument based on whether or not the slope falls within a predetermined range.

2. The flow meter device according to claim 1, further comprising:
a history storage section for storing a history of the flow measured by the flow measuring section;
wherein the measurement data processing section identifies at least one of a time when a use of the particular fluid instrument has started and a time when the use of the particular fluid instrument has ended, based on the history of the flow stored in the history storage section, when the measurement data processing section determines that the fluid instrument in use is the particular fluid instrument.

3. The flow meter device according to claim 2,
wherein the measurement data processing section identifies the time when the use of the particular fluid instrument has started, based on an event that the history of the flow corresponding to the determination has started to rise from a predetermined flow.

4. The flow meter device according to claim 2,
wherein the measurement data processing section identifies the time when the use of the particular fluid instrument has ended, based on an event that the history of the flow corresponding to the determination has fallen to a predetermined flow and finishes changing.
